(19) United States
(12) Patent Application Publication
(10) Pub. No.: US 2014/0060353 A1
(43) Pub. Date: Mar. 6, 2014

(54) Rotary press comprising at least two pront towers and a lift

(71) Applicant: Goss International Corporation, (US)

(72) Inventors: Sylvain Guy Lepinay, Reze (FR); Alain Guiffant, Basse Goulaine (FR)

(73) Assignee: Goss International Corporation, Durham, NH (US)

(21) Appl. No.: 13/871,755

(22) Filed: Apr. 26, 2013

(30) Foreign Application Priority Data
Apr. 27, 2012 (FR) 12 53959

(51) Int. Cl. B41F 13/00

(52) U.S. Cl. CPC B41F 13/00
USPC 101/216

(57) ABSTRACT

A rotary press is provided. The rotary press includes a plurality of print towers aligned in a longitudinal direction, each print tower having a frame stationary relative to the ground, and at least one lift designed to move people. The at least one lift may be an intermediate lift designed to move people. The intermediate lift is positioned so the lift is vertically movable in an intermediate space between two adjacent print towers, and serves both print towers between which the lift is positioned.

Priority is hereby claimed to French Patent Application No. 12 53959 filed on Apr. 27, 2012, the entire disclosure of which is hereby incorporated by reference herein.

The present invention relates to the field of rotary presses, and in particular a rotary press comprising at least two print towers.

### BACKGROUND

A print tower is very tall. To use or maintain the rotary press, it is necessary to have easy access to the upper part of each print tower, for example to access printing units of the print towers situated at a height from the ground.

EP 2,195,163 discloses a print tower comprising two frames that are movable relative to one another and several vertically superimposed print units, each mounted partially on one frame and partially on the other frame, to make it possible to separate the frames to access the print units between the frames. The print tower comprises two lateral lifts outside the frames and a central lift movable between the two frames separated from each other.

It is necessary to provide a sufficient separation between such print towers to allow the movement of the moving frames of each print tower in the open position. The rotary press made up of such print towers must be installed in a large building, which may pose problems when the rotary press must be installed in an old building, for example to replace an old rotary press.

### SUMMARY OF THE INVENTION

An object of the present invention provides a rotary press allowing a compact arrangement, while being easy to operate and maintain.

The present invention provides a rotary press comprising several print towers aligned in a longitudinal direction, each print tower having a frame stationary relative to the ground, and at least one lift designed to move people, the rotary press comprising at least one intermediate lift designed to move people, positioned vertically movably in an intermediate space between two adjacent print towers, and serving both print towers between which it is positioned.

According to other embodiments, the press may include one or more of the following features, considered alone or according to all technically possible combinations:
the rotary press comprises an intermediate lift between each pair of adjacent print towers;
the rotary press comprises at least one end lift mounted vertically movably along a print tower situated at the end of the alignment of print towers, on the side of the print tower opposite the other print towers of the alignment;
each intermediate lift is movably mounted on the frame of only one of the two print towers between which it is located, on the frames of two print towers between which is located, or on a dedicated frame;
at least one lift, preferably each lift, is configured to move from an extreme low position to an extreme high position defining a maximum operating height at which the lift systematically stops, and to move from the first height to a second maintenance height, the first height being lower than the second height;
each print tower comprises several vertically superimposed print units;
each print tower comprises blanket-to-blanket double-sided print units;
each print tower comprises satellite print units, one-sided or two-sided, with five, seven or nine cylinders.

### BRIEF DESCRIPTION OF THE DRAWINGS

The invention and the advantages thereof will be better understood upon reading the following description, provided solely as an example and done in reference to the sole FIGURE illustrating a rotary press in side view.

### DETAILED DESCRIPTION

As illustrated in the FIGURE, the rotary offset press 2 comprises several print towers 4, each for offset printing a respective continuous web 6, in particular a web of paper.

The rotary press 2 traditionally comprises an assembly for combining webs printed by the different print towers 4 making it possible to ensure gathering, folding and longitudinal and/or transverse cutting of the webs and/or assembly devices by stapling and/or gluing, to provide notebooks or signatures as output.

The rotary press 2 traditionally comprises an emptying device associated with each print tower 4 to unwind the web 6 from a spool.

Each print tower 4 comprises print units 8. Each print unit 8 comprises at least one printing group 10 to print one face of the web 6.

Each printing group 10 comprises a form cylinder 12, a transfer cylinder 14, an ink portion 15, a wetting portion 17, and a plate changing unit 19.

The form cylinder 12 bears the forms to be printed on its periphery. The form cylinder 12 is for example a plate cylinder provided for removable fastening of flexible plates (not shown) bearing the forms to be printed. The plates are changed as a function of the productions to be done. The form cylinder 12 bears one or more plates side-by-side axially along the axis of the cylinder. The form cylinder 12 bears one or more plates in turn, one behind the other on the circumference of the form cylinder 12. The form cylinder 12 is for example of the 4×1, 4×2, 5×2, or 6×2 type, the first number designating the number of plates axially side by side, and the second number designating the number of plates in turn.

The transfer cylinder 14 is positioned to be pressed against the form cylinder 12 and to transfer ink from the form cylinder 12 onto the web 6. The transfer cylinder 14 is for example a blanket cylinder designed to receive a blanket on its periphery.

The axes of the form cylinder 12 and the transfer cylinder 14 are parallel.

In the illustrated example, each print tower 4 is a double-sided four-color tower comprising four double-sided print units in a blanket-to-blanket configuration. Each print unit 8 is provided to print one respective color on the web 6. The colors typically used are: black, cyan, magenta and yellow. Each print unit 8 comprises two printing groups 10, whereof the transfer cylinders 14 are pressed against each other and pinch the web 6 during performance of the printing work. Each transfer cylinder 14 defines a print cylinder for the other.

The print towers 4 are aligned in a longitudinal direction L. The print towers 4 are regularly spaced in the longitudinal direction L. The separation E between each pair of adjacent print towers 4 is constant.

The print towers 4 define intermediate spaces 18 between them. Each intermediate space 18 is delimited between two consecutive print towers of the alignment of print towers 4. The intermediate spaces 18 have lengths in the longitudinal direction L that are substantially equal to the separation E.

As illustrated in the FIGURE, the rotary press 2 comprises an alignment of four print towers 4 defining three intermediate spaces 18 between them.

Each print tower 4 comprises a frame 20 supporting the cylinders 12, 14 of the print units 8, each cylinder 12, 14 being rotatably mounted around its axis on the frame 20. The frame 20 of each print tower 4 is immobile relative to the ground S. It is rigidly fixed to the ground S. Thus, each intermediate space 18 has an invariable length.

The frame 20 of each print tower 4 has two lateral chasses 22 transversely spaced apart, only one lateral chassis 22 being shown in the FIGURE. The cylinders 12, 14 of the print units 8 extend transversely between the two lateral chasses 22 (perpendicular to the plane of the FIGURE) and while being rotatably mounted at the axial ends on each of the two lateral chasses 22.

The print towers 4 have a height of several meters, for example a height of approximately 4 m.

During exploitation operations or maintenance operations, it is necessary to be able to access the various print units 8 of each print tower 4, in particular the print units of the upper part of each print tower 4, situated at a height that is difficult for an operator to access from the ground S.

The rotary press 2 comprises at least one lift (or elevator) designed to move people vertically movably mounted along at least one print tower 4 to allow operators to access the print units 8 of the upper part of the print tower 4.

The rotary press 2 here comprises several lifts, distributed so as to enable access to the upper part of each print tower 4.

Each lift is designed to move people and also makes it possible to move loads, in particular to raise or lower elements of the print units, such as rollers, blanket washing bars, plate change cartridges, etc.

The rotary press 2 comprises at least one intermediate lift 24 positioned in the intermediate space 18 between two adjacent print towers 4 and serving two adjacent print towers 4 defining the intermediate space 18. Each intermediate lift 24 allows an operator to access the print units of each of the two print towers 4 between which it is disposed. Each intermediate lift 24 has a width substantially equal to that of the intermediate space 18 in which it is received.

The rotary press 2 comprises an intermediate lift 24 between each pair of adjacent print towers 4.

Each intermediate lift 24 is mounted vertically movably on the frame 20 of at least one of the two print towers 4 that it serves. Each intermediate lift 24 is movably mounted on the frame 20 of only one from among the two print towers 4 or on the frames 20 of both print towers 4.

Alternatively, each intermediate lift 24 is movably mounted on a specific frame positioned between the frames 20 of the two print towers 4.

The rotary press 2 further comprises two end lifts 30 each positioned along a print tower 4 situated at the end of the alignment of print towers 4, on the side of the print tower 4 opposite the adjacent print tower 4 of the alignment of print towers 4.

Each end lift 30 is dedicated to one end print tower 4. It makes it possible to access the associated print tower 4 on the side that is not served by an intermediate lift 24.

Each intermediate lift 24 or end lift 30 comprises a platform 26 and a railing 28 to secure access thereto.

At least one lift, and preferably each lift, is configured to move from a low extreme position to a first height H1 defining a maximum operating height, while systematically stopping at the first height H1.

The travel between the extreme low position and the first height H1 is chosen to allow an operator to access the highest print groups of the print tower to perform exploitation operations therein. The first height H1 in particular makes it possible to access the plate changing unit 19 of the uppermost print group.

At least one lift, and preferably each lift, is configured to move from the first height H1 to a second height H2 higher than the first height H1, preferably following a specific manual action by the operator. Such a manual action is for example prolonged pressure on a control button commanding the lift to rise.

The second height H2 is chosen to allow an operator to perform maintenance operations on the rotary press 2. It makes it possible, for example between performing printing jobs, to access the top part of the print tower 4, and in particular above the uppermost printing unit of the print tower, at the passage of the webs and in the surrounding area of the print tower 4.

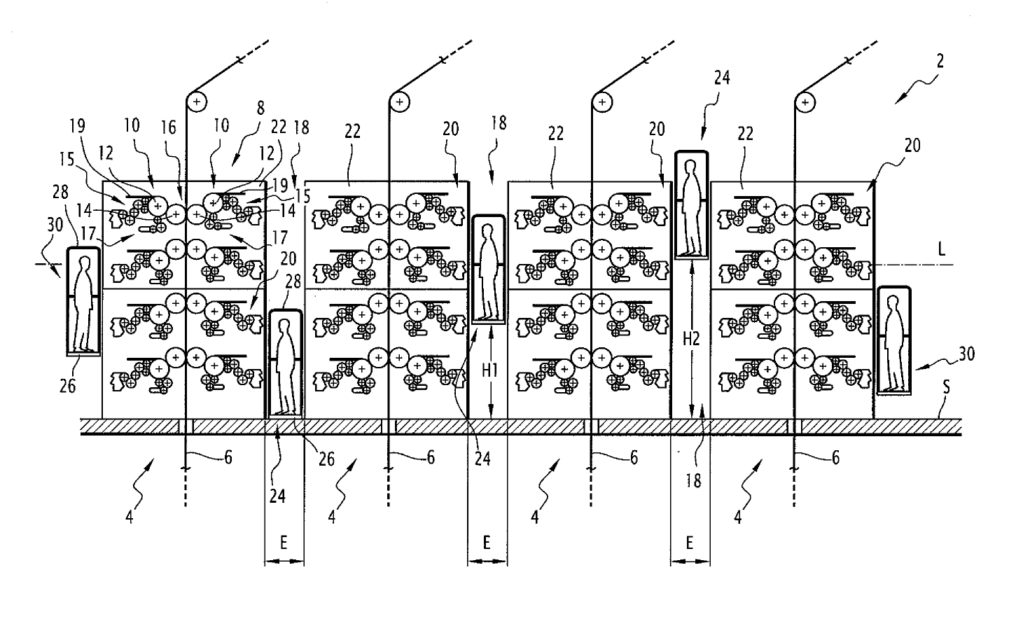

FIG. 1 shows, from left to right, an intermediate lift 24 in the extreme low position, an intermediate lift 24 at the first height H1, and an intermediate lift at the second height H2.

The first height is for example approximately 3 m and the second height is approximately 4 m.

The fixed print towers have limited site coverage and require limited separation between the print towers. They in particular require a lower separation than between print towers comprising two parts longitudinally movable relative to one another to allow access between the moving parts.

The rotary press made up of fixed print towers with a small separation has a low overall bulk allowing it to be installed in old or new buildings with a reduced size.

The use of lifts to access the upper parts of the print tower advantageously replaces the use of catwalks defining an access stage to those upper parts, insofar as the print towers illustrated are vertically compact, such that the available height at the ground, under the catwalks, is limited.

The intermediate lift serving two adjacent print towers enables easier access to the various print towers while simplifying the rotary press and limiting the cost thereof.

The rotary press according to the invention comprises at least two print towers. It comprises two, three, four (as illustrated in the FIGURE) or more print towers.

The illustrated rotary press comprises print towers with four superimposed double-sided printing units, each in a blanket-to-blanket configuration with four cylinders.

The rotary press may comprise print towers having superimposed print units with different configurations. A rotary press may for example comprise print towers with several superimposed printing units, in a one-sided configuration, a blanket-to-blanket double-sided configuration or a satellite configuration, one-sided or two-sided, with five, seven or nine cylinders.

What is claimed is:

1-8. (canceled)

9. A rotary press comprising:
a plurality of print towers aligned in a longitudinal direction, each print tower having a frame stationary relative to the ground; and
at least one intermediate lift designed to move people, the at least one intermediate lift being vertically movable in an intermediate space between two adjacent print towers, and serving both print towers between which the at least one intermediate lift is positioned.

10. The rotary press according to claim 9, further comprising an intermediate lift between each pair of adjacent print towers.

11. The rotary press according to claim 9, further comprising at least one end lift vertically movable along a print tower situated at the end of the alignment of print towers, on the side of the print tower opposite the other print towers of the alignment.

12. The rotary press according to claim 9, wherein each intermediate lift is movably mounted on the frame of only one of the two print towers between which each intermediate lift is located, on the frames of two print towers between which each intermediate lift is located, or on a dedicated frame.

13. The rotary press according to claim 9, wherein at least one lift is configured to move from an extreme low position to a first height (H1) defining a maximum operating height at which the lift systematically stops, and to move from the first height (H1) to a second maintenance height (H2), the first height (H1) being lower than the second height (H2).

14. The rotary press according to claim 9, wherein each print tower includes several vertically superimposed print units.

15. The rotary press according to claim 14, wherein each print tower includes blanket-to-blanket double-sided print units.

16. The rotary press according to claim 14, wherein each print tower includes satellite print units, one-sided or two-sided, with five, seven or nine cylinders.

17. The rotary press according to claim 13, wherein each lift is configured to move from an extreme low position to a first height (H1) defining a maximum operating height at which the lift systematically stops, and to move from the first height (H1) to a second maintenance height (H2), the first height (H1) being lower than the second height (H2).
